(19) United States
(12) Patent Application Publication
(10) Pub. No.: US 2009/0026373 A1
(43) Pub. Date: Jan. 29, 2009

(54) System for Producing and Checking Tablets

(75) Inventors: Richard Mertens, Laupheim (DE); Heino Prinz, Laupheim (DE)

Correspondence Address: JANSSON SHUPE & MUNGER LTD., 245 MAIN STREET, RACINE, WI, 53403, US

(73) Assignee: UHLMANN VISIOTEC GMBH, Laupheim (DE)

(21) Appl. No.: 12/175,951

(22) Filed: Jul. 18, 2008

(30) Foreign Application Priority Data
Jul. 24, 2007 (EP) EP 07 014 518.0

(51) Int. Cl. G01J 5/02; G01F 17/00

(52) U.S. Cl. 250/339.07; 73/149

(57) ABSTRACT

A system for inspecting tablets includes an NIR measuring device for determining the concentration of at least one active ingredient in the tablets. The system also includes a sensor for determining the volume of the individual tablet, and a control unit which is able to calculate the actual active ingredient dose of the tablet under consideration of the data acquired by the NIR measuring device and the volume-determination sensor. A corresponding method of inspecting tablets is also described.

### CROSS REFERENCE TO RELATED APPLICATION

This application claims priority based on European patent application EP 07 014 518.0, filed Jul. 24, 2007.

### FIELD OF THE INVENTION

The invention pertains to systems for inspecting tablets.

### DESCRIPTION OF THE PRIOR ART

Tablets are usually produced by means of tablet presses, most of which are designed as rotary tablet presses. The die cavities of the tablet press are first filled with a premixed powdered substance, and then two punches of suitable shape compress the powder into the desired tablet shape. The finished tablets are then ejected from the rotary press and usually conducted to a container, in which a large number of tablets are held for intermediate storage. The tablets from the container are then checked for quality and sent to a packaging system.

Careful inspections are required, because pharmaceutical products must meet strict quality criteria. In particular, the dose of active ingredient must lie within the approved tolerances. Another parameter is the compressed hardness of the tablets. The quantitative and hardness determinations are usually performed on the basis of random samples and in the form of destructive tests. The preferred analysis methods are based on liquid chromatography, gas chromatography, and spectroscopy, some of which require that the samples be further processed. For the hardness measurement, a destructive mechanical strength analysis is usually conducted. These methods are characterized by relatively high precision, but the speed at which the analyses can be performed is rather slow. These methods are therefore not suitable for supplying quick results for each tablet or even during the production process itself.

So that quantitative conclusions concerning the concentration of active ingredient in each individual tablet produced can be obtained during the tablet production process itself, it is known from EP 1 600 761 A1 or EP 1 568 480 A2, for example, that a near-infrared (NIR) measuring device can be integrated into a tablet press to analyze the composition of moving tablets in real time. Thus, it became possible for the first time to subject tablets to spectroscopic examination without gaps immediately after their production. Other NIR measurement devices examine the tablets outside the tablet press during transportation to the packaging station.

Nevertheless, NIR spectroscopy cannot provide all the data relevant to a quality inspection. Additional examination methods must therefore still be used afterwards to make it possible to determine the actual dose of active ingredient in each tablet. In this regard, reference can be made by way of example to a sensor for volume measurement described in EP 1 193 177 A1.

### SUMMARY OF THE INVENTION

It is an object of the invention to provide a system for inspecting tablets which has a high rate, ensures quantitative determination of the dose of active ingredient of each individual tablet, operates very safely and reliably, and discovers defects in the production process quickly. A corresponding method of inspecting tablets is also provided.

According to an aspect of the invention, the system for inspecting tablets comprises an NIR measuring device to determine the concentration of at least one active ingredient in the tablets. In addition, the system comprises a sensor for determining the volume of each tablet and a control unit which is able to calculate the absolute active ingredient dose of the tablets under consideration of the data acquired by the NIR measuring device and the volume-determination sensor.

Preferably, the NIR measuring device is integrated into a tablet press. Alternatively, the system according to the invention can be used as a separate device during transportation of the tablets outside the table press. The measuring results may be used to influence the control of the tablet production process on the basis of the calculated value.

On the basis of this combination of detector arrangements and corresponding control units, it is possible for the first time to draw direct conclusions concerning the dosage of each individual tablet in the tableting process and also to use this information to control the process parameters directly.

An especially rapid NIR measuring device comprises at least one radiation source, which emits radiation in the near-infrared to irradiate the tablet; a measuring head containing a radiation receiver arrangement, which receives the radiation reflected by the tablet; a spectrometer for receiving the radiation from the radiation receiver arrangement and for preparing an output signal corresponding to the intensity of the received radiation at a number of different wavelengths; and a device for determining the concentration of at least one active ingredient present in the tablet on the basis of the output signal.

To avoid contamination and to keep the inspection conditions constant, the measuring head of the NIR measuring device has an NIR-transparent glass window and openings through which an air curtain can be blown in or through which air can be drawn out.

An especially fast and reliable type of sensor for determining volume is a capacitive measuring sensor. This sensor preferably comprises a voltage generator for an alternating electrical field, two opposing capacitor plates, and an ammeter.

To set the correct recording times, the times at which the measurements of the NIR measuring device are triggered are correlated with the transport speed of the tablet press.

The inventive method of inspecting tablets includes the following steps: determining the concentration of at least one active ingredient in the individual tablet by means of an NIR measurement device; determining the volume of the tablet by a sensor; and calculating the absolute active ingredient dose of the tablet under consideration of the data acquired by the NIR measuring device and the volume-determination sensor.

In a preferred embodiment, the method includes the further step of controlling the production process of the tablets on the basis of the calculated value.

For the determination of the active ingredient concentration in the tablet, the measured NIR spectrum is preferably compared with a model spectrum.

After the volume determination, the weight of the tablet is determined from the determined volume of the tablet by the use of information on the density of the compressed tablet, which has been acquired from the compressing force of the tablet press and/or from the spectrum determined by the NIR measuring device. As a result, a superior basis for determining the active ingredient dose present in the tablet is created.

The tablet production process can be controlled in various ways, some of which can be used in combination, e.g., turning off the tablet press, adjusting the compressing force of the tablet press punches, and adjusting the quantity or mixing ratio of the tablet powder.

### BRIEF DESCRIPTION OF THE DRAWINGS

Additional details, features, and advantages of the present invention can be derived from the following description, which refers to the drawings.

FIG. 1 is a perspective schematic diagram of an embodiment of the inventive system for inspecting tablets;

FIG. 2 is a schematic diagram of the sequence of steps of the NIR measurement, including some of the components of the NIR measuring device and of the associated electronic evaluation unit;

FIG. 3 is a schematic cross-sectional diagram, on an enlarged scale, of part of the tablet press with integrated NIR measuring device;

FIG. 4 is a schematic diagram of the sensor used for volume determination; and

FIG. 5 is a flow chart of the process for inspecting tablets.

### DETAILED DESCRIPTION OF THE INVENTION

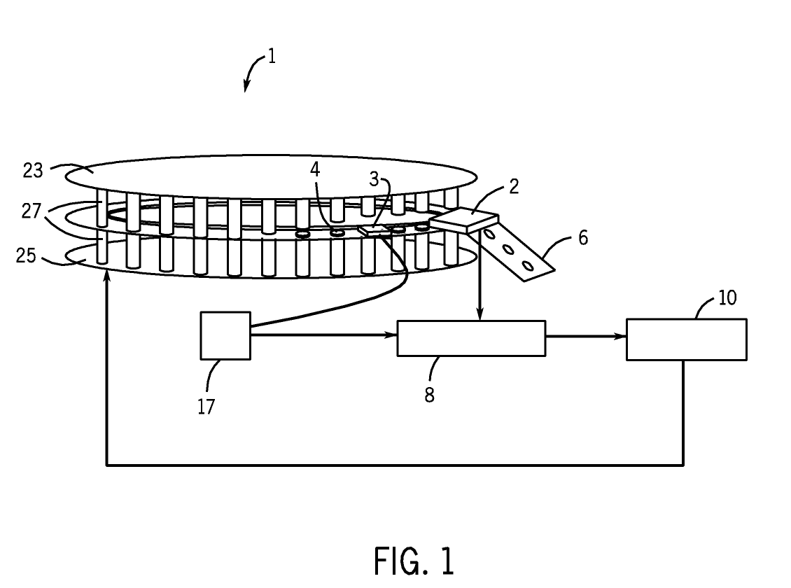

The system for producing and inspecting tablets shown in FIG. 1 comprises a rotary tablet press 1; an NIR measuring device 3 integrated into the press; and a sensor 2 for determining the volumes of the produced tablets 4 located in the area where tablets 4 are ejected from the tablet press 1. After the compressing operation, tablets 4 are first examined by the NIR measuring device 3 and then by sensor 2. They are then conducted by way of an ejection chute 6, for example, into a container or onto a conveyor belt. Sensor 2 is usually set up outside tablet press 1, wherein, for example, a guide plate guides tablets 4 out of tablet press 1 and moves them toward sensor 2. A detailed description of the NIR measuring device 3 and of the volume-determination sensor 2 is provided further below.

The system also comprises a control unit 8 which is supplied with the results of the NIR measuring device 3 and of volume-determination sensor 2 and which is connected to the control unit 10 of tablet press 1. In a special embodiment, control unit 8 can also function directly as control unit 10 of tablet press 1.

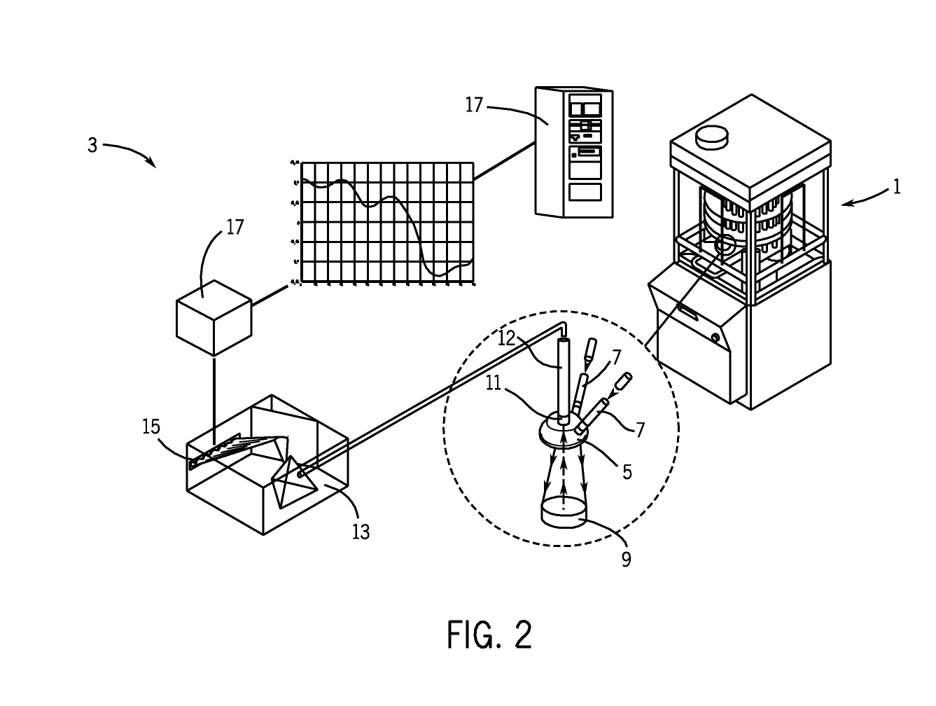

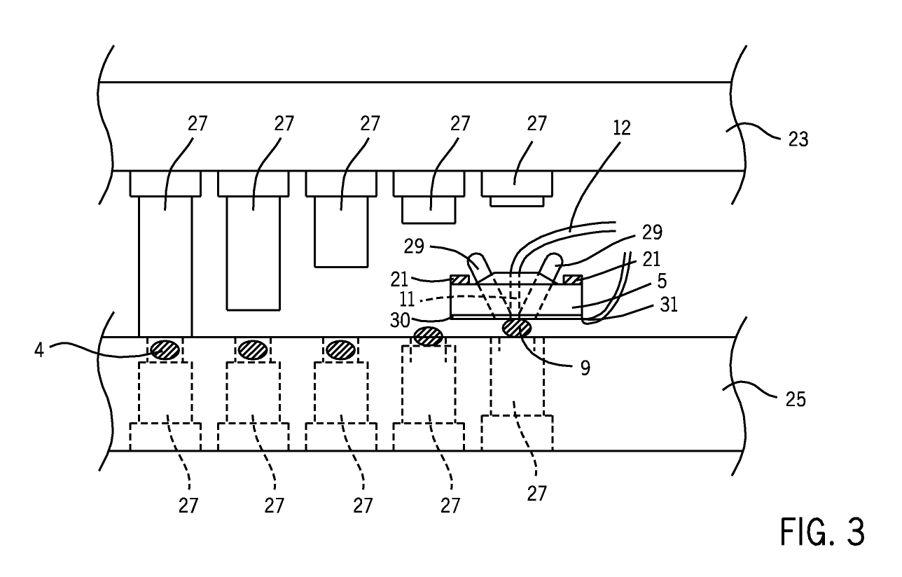

FIG. 2 is a schematic diagram of the sequence of steps of the NIR measurement with a preferred embodiment of the NIR measuring device 3. The elements of the integrated NIR measuring device 3 are shown individually for the sake of clarity. NIR measuring device 3 comprises at least one near-infrared radiation source 29 (FIG. 3) such as a mercury-halogen lamp or a tungsten-halogen lamp. The measuring head 5 is installed permanently, for example, inside tablet press 1 in the area between the upper and lower revolving punches. The near-infrared radiation emitted by the radiation source is conducted to measuring head 5 by, for example, two light guides 7 and from there is conducted symmetrically to the previously compressed tablet 4. Alternatively, the radiation sources 29 can be mounted on measuring head 5 itself to irradiate tablet 4 directly by way of a suitable lens, as shown in FIG. 3.

The radiation diffusely reflected from tablet 4 is received by the radiation receiver arrangement 11, also located in measuring head 5, preferably through a converging lens (not shown) and sent to the spectrometer 13 by a light guide 12. In spectrometer 13, the reflected radiation, which contains the spectral information of irradiated tablet 4, is split up into radiation of different wavelengths in the known manner by means of a grating, for example, and detected by a photodiode array 15. The current from each photodiode is integrated over a preselected time period (preferably less than 10 ms), and the intensities detected by the photodiode array 15 as a function of wavelength are then converted into digital signals in the determination device 17 by means of an A/D converter and evaluated by a computer.

On the basis of the output signal provided at the various wavelengths, a mathematical process is used in the determination device 17 to determine the concentration of at least one active ingredient present in tablet 4. The electronics must be able in this case to get the output signals from array 15 within 1 ms.

Suitable mathematical procedures for determining the relative concentration of the active ingredient are procedures of multivariate data analysis. Suitable procedures include, for example, the PLS (partial least square) procedure and primary component analysis (PCA). In these procedures, the differences between a model spectrum obtained in the usual way and the spectrum of tablet 4 to be measured are calculated at each measured wavelength. For the evaluation, the mathematical procedures can use weighting factors to reduce the influence of interfering variabilities in the recorded NIR spectra attributable to the composition and can emphasize spectral features which do not vary between samples of the same type of tablet.

FIG. 3 is a schematic cross-sectional diagram of a preferred embodiment of NIR measuring device 3, in which measuring head 5 is mounted in stationary fashion on tablet press 1 by means of known fastening elements 21. The upper and lower turret heads 23, 25 carry a fixed number of punches 27, each with a cross section and a compressing surface designed to produce tablets of the desired shape. During a production cycle, each individual tablet 4 is compressed by punches 27 in accordance with a specific pressure curve, so that it has the defined final shape before it is ejected. Upper and lower turret heads 23, 25 usually move at uniform speed. Punches 27 release tablet 4 at a defined release position which is the same for all of tablets 4. At exactly this position, the components mounted on the stationary measuring head 5 irradiate the tablet with NIR radiation and make the measurement.

To avoid contamination and thus measurements falsified by possible systematic errors, an NIR-transparent glass window 30 is provided at the bottom of measuring head 5. This window can also have a self-cleaning surface designed on the basis of nanotechnology. Measuring head 5 can also have suitably shaped openings 31, through which an air curtain can be blown in to protect against contamination and/or through which air can be drawn out. Thus it is ensured that the measuring conditions present at the optical elements of measuring head 5 remain constant.

Preferably each individual tablet 4 is irradiated, as previously mentioned, at a fixed location within rotary tablet press 1, namely, at the point where the revolving punches 27 release the finished compressed tablet 4 but before the tablet is transported any farther. In principle, the use of a movable sensor head, which moves along with tablet 4 for a few milliseconds, is also conceivable. The geometry of tablet press 1, that is, the radius of the die and the exact position of punches 27 at the compressing location, and the circumferential velocity of tablet press 1 are the criteria which determine how often a measurement must be initiated. The arrival of a certain point on the tablet (e.g. the center point of the surface visible from above) precisely defined for measurement in the NIR beam characterizes the exact starting time for the measurement, i.e., the trigger point.

The time interval between two measurements is defined by the length of time between two trigger points. The integration time period is started by means of a trigger function which is automatically calculated and initiated on the basis of the previously mentioned properties and settings (speed, dimensions, etc.) of tablet press 1 or alternatively is initiated by a light barrier upon passage of a tablet 4 through a certain location.

The data acquired via the NIR measurement must then be stored for a certain period of time until the volume measurement results are also available for the tablet in question. Here, too, the correct assignment of the results is accomplished under consideration of the speed of tablet press 1.

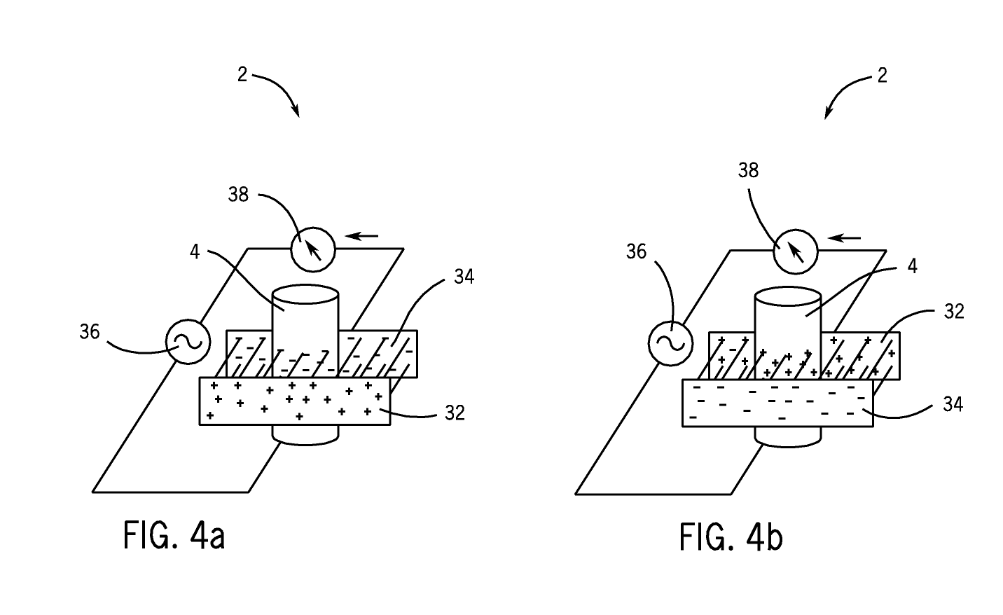

FIG. 4 shows the design principle of sensor 2 used to measure the tablet volume. Sensor 2 is designed as a capacitive measuring sensor and comprises two capacitor plates 32, 34, between which each tablet 4 is carried on its way from the point at which it is ejected from tablet press 1 to ejection chute 6. A voltage generator 36 for alternating voltage charges the capacitor plates 32, 34 oppositely to each other at very short time intervals. The two parts of the figure show the charge states of two capacitor plates 32, 34 when the two opposite voltages are being applied. On the left, capacitor plate 32 is positively charged and capacitor plate 34 is negatively charged, whereas, on the right, capacitor plate 32 is positively charged and capacitor plate 34 is negatively charged. As a result of the change in the applied voltage U_{Generator}(t), minimal polarization changes occur in tablet 4, representing in itself an insulator, in the alternating electrical field. These small polarization changes can be recorded by an ammeter 38. The measured current I_{M}(t) is proportional to the number of charged particles in tablet 4 and thus, under the assumption of constant density, it is also proportional to its volume.

Sensor 2 for volume determination can be realized in many different ways as long as the basic design described in FIG. 4 is maintained. In every case, it is necessary to record appropriate reference models for the types of tablets of interest so that sensor 2 can be calibrated for the area of application in question. It is especially important to determine in advance, by a separate procedure, the density of compressed tablet 4 at specific settings of tablet press 1. As long as the compressing force of tablet press 1 is always set at the same value, it is then possible, independently of the amount of powder supplied, to assume that produced tablets 4 have a constant density.

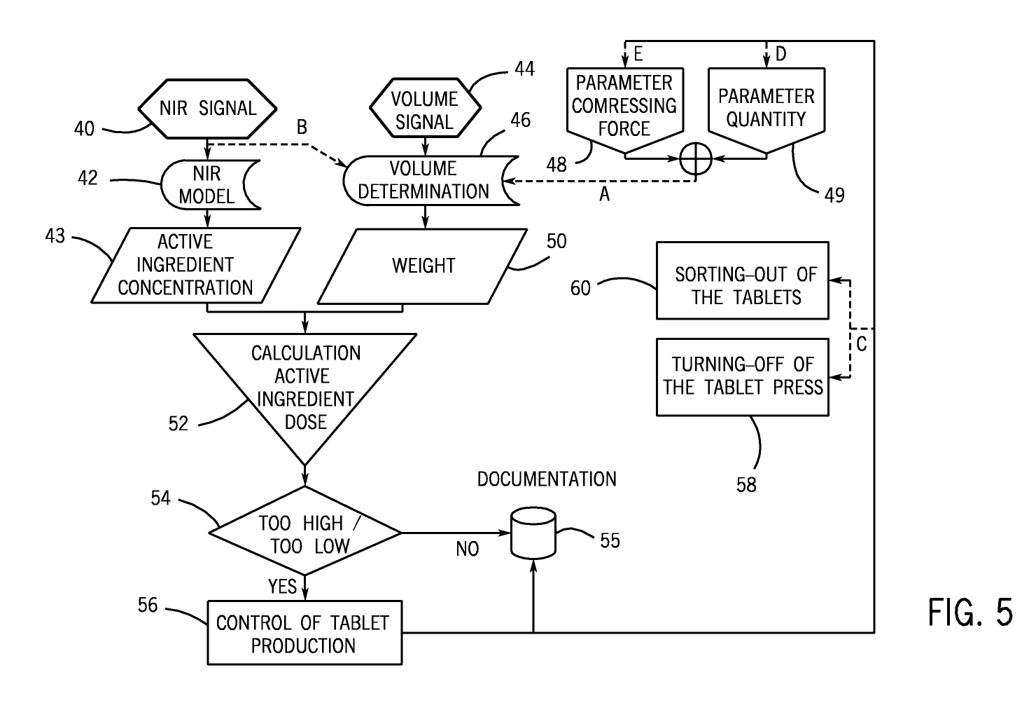

FIG. 5 is a schematic flow chart of the process for inspecting compressed tablets 4. First, an NIR signal is recorded by NIR measuring device 3 (step 40) and compared with an NIR model spectrum adapted to the desired criterion (step 42). As a result of this comparison, it is then possible, in step 43, to calculate the active ingredient concentration in tablet 4 in question. Then volume-determination sensor 2 records its measurement signal (step 44), and the actual volume of tablet 4 is determined on passage of the tablet through sensor 2 by comparison with the reference values (step 46).

So that the weight of tablet 4 in question can be calculated from its volume acquired in this way, it is also necessary to have information on its density, which is usually available on the basis of data on the compressing force 48 of tablet press 1 (arrow A in broken line). The quantity 49 of tablet powder in the die cavity between punches 27 of tablet press 1 can also be important. As an alternative, it is also possible in certain cases to derive data on tablet hardness and thus on the density of tablet 4 from the acquired NIR spectrum. For the purpose of weight determination, these data can be used as an alternative to the data on compressing force 48; this is indicated by the arrow B. From these data, the weight of preferably each individual tablet 4 is then calculated (step 50).

The actually desired result, namely, the absolute active ingredient dose in tablet 4, is now obtained by calculation under consideration of the determined active ingredient concentration and the determined weight (step 52). The active ingredient dose is then compared with reference values (step 54) to determine whether or not the active ingredient dose is within the allowed tolerances. If the active ingredient dose is in the correct range, this fact is merely documented in step 55. If the active ingredient dose is too high or too low, action is taken on the control of tablet production in accordance with the inventive process (step 56). This intervention is also documented.

There are various ways in which tablet production can be controlled when defective tablets are being produced. These possibilities can be implemented in combination with each other or individually in the system in question. Thus, the simplest measure, according to arrow C, is to turn off the tablet press (step 58) to prevent the production of even more defective tablets 4. At the same time, defective tablets 4 already produced should also be sorted out (step 60). It is also possible, on the basis of the calculated active ingredient dose, to adjust the parameter quantity 49 (arrow D) and/or the parameter compressing force 48 (arrow E) of tablet press 1 in a controlled manner so as to produce tablets 4 which are within the tolerance range.

Defects during tablet production are usually caused by separation of the powder components or by a change in the quantity of powder. These defects can be detected with superior efficiency by the process cited above.

By means of the system described here, more than 1,000,000 tablets per hour can be produced and analyzed with precision, wherein the tablet data are recorded by the NIR measuring device within a time window of less than 10 ms, preferably of less than 7 ms, and more preferably of less than 2 ms. The volumes are measured at an equivalent speed. The length of time between these two measurements of the same tablet 4 ranges from 20 to 500 ms, so that a period of time ranging from 70 to 550 ms can be estimated as the total response time of the system from production to evaluation. A control measure can then be initiated in the tableting process after only this short time.

Although the system has been described as integrated in a tablet press, the inventive system for inspecting tablets can also be installed at any position after discharge of the tablets from the tablet press, e.g., during transportation of the tablets from the tablet press to the packaging units.

The term “tablet” should be construed to cover any solid pharmaceutical product.

1. A system for inspecting tablets including an NIR measuring device for determining the concentration of at least one active ingredient in the tablets, comprising:
a sensor for determining the volume of each tablet; and
a control unit to calculate the absolute dose of active ingredient in the tablet under consideration of the data acquired by the NIR measuring device and the volume-determination sensor.

2. The system of claim 1 further comprising a tablet press into which the NIR measuring device is integrated, wherein the sensor for determining the volume of each tablet is positioned in the area where the tablet is ejected from the press and wherein the control unit is adapted to influence the control of the production process of the tablets on the basis of the calculated value.

3. The system of claim 1 wherein the NIR measuring device comprises:
at least one radiation source emitting radiation in the near-infrared for irradiating the tablet;
a measuring head containing a radiation receiver arrangement, which receives the radiation reflected by the tablet;
a spectrometer for receiving the radiation from the radiation receiver arrangement and for providing an output signal corresponding to the intensity of the received radiation at a number of different wavelengths; and
a device for determining the concentration of at least one active ingredient present in the tablet on the basis of the output signal.

4. The system of claim 1 wherein the volume-determination sensor is a capacitive measuring sensor.

5. The system of claim 4 wherein the volume-determination sensor comprises a voltage generator for an alternating electrical field, two opposing capacitor plates, and an ammeter.

6. The system of claim 2 wherein the times at which the measurements by the NIR measuring device are triggered are correlated with the transport speed of the tablet press.

7. A method of inspecting tablets, comprising the steps of:
determining the concentration of at least one active ingredient in the individual tablet by means of an NIR measuring device;
determining the volume of the tablet by a sensor; and
calculating the absolute active ingredient dose of the tablet under consideration of the data acquired by the NIR measuring device and the volume-determination sensor.

8. The method of claim 7 further comprising controlling the production of the tablets on the basis of the calculated value.

9. The method of claim 7 wherein the step of determining the active ingredient concentration in the tablet comprises the step of comparing a measured NIR spectrum with a model spectrum.

10. The method of claim 7 wherein, after the step of volume determination, the weight of the tablet is determined from the determined volume of the tablet with the help of data on the density of the tablet, which can be acquired from the compressing force of the tablet press and/or from the spectrum determined by the NIR measuring device.

11. The method of claim 8 wherein the controlling step comprises at least one of the following steps:
turning off the tablet press,
adjusting the compressing force of the punches of the tablet press, and
adjusting the quantity of tablet powder.
